(19) United States
(12) Patent Application Publication
(10) Pub. No.: US 2026/0168426 A1
(43) Pub. Date: Jun. 18, 2026

(54) METHOD AND DEVICE FOR REGENERATING EXHAUST PARTICULATE FILTER IN V-TYPE INTERNAL COMBUSTION ENGINE

(71) Applicant: NISSAN MOTOR CO., LTD., Yokohama-shi (JP)

(72) Inventors: Isamu UEHARA, Kanagawa (JP); Akikazu SAKAI, Kanagawa (JP); Hiroyuki ITOYAMA, Kanagawa (JP)

(73) Assignee: NISSAN MOTOR CO., LTD., Yokohama-shi (JP)

(21) Appl. No.: 19/422,128

(22) Filed: Dec. 16, 2025

(30) Foreign Application Priority Data
Dec. 17, 2024 (JP) 2024-220466

(51) Int. Cl. F01N 13/00; F01N 9/00; F01N 11/00; F02B 75/22; F02P 5/15

(52) U.S. Cl. CPC F01N 13/011; F01N 9/002; F01N 11/00; F02B 75/22; F02P 5/1504; F01N 2900/1606

(57) ABSTRACT

The soot accumulation amount for each of the exhaust particulate filters 7 and 8 of banks in a V-type internal combustion engine is estimated, and when the soot accumulation amount of the exhaust particulate filter 8, which has a lower soot accumulation amount, exceeds a first threshold SL1, regeneration process for both the banks starts. The regeneration process is terminated when the soot accumulation in the exhaust particulate filter 7, which has a higher soot accumulation amount, reaches a lower limit soot amount Min by the regeneration process. Since the soot accumulation in the other exhaust particulate filter 8 does not fall below zero, the difference in soot accumulation amounts between the two exhaust particulate filters 7 and 8 becomes small. The soot accumulation amount of one exhaust particulate filter 7 is limited to the lower limit soot amount Min, the collection efficiency is ensured.

### BACKGROUND

The present invention relates to a method and device for regenerating an exhaust particulate filter in a V-type internal combustion engine, which is provided with a pair of banks, and an exhaust particulate filter provided in the exhaust passage of each of the banks.

In recent years, with increasing demands for exhaust purification performance in automobiles, not only diesel engines with high particulate emission amounts, but also spark-ignition internal combustion engines (so-called gasoline engines), an exhaust particulate filter tends to be provided in an exhaust system to remove soot from the exhaust. Then, in a V-type internal combustion engine having a pair of left and right banks, an exhaust particulate filter may be disposed in the exhaust passage of each of the independent banks.

Excessive soot accumulation in the exhaust particulate filter causes a so-called clogged state, leading to a decrease in output. Therefore, a regeneration process is necessary at an appropriate time to remove the soot by forcibly increasing exhaust temperature.

A Japanese Patent Application Publication No. 2008-111392 (hereinafter is simply referred to as a “patent document 1”) discloses a technique for regenerating only the exhaust particulate filter of one of the banks of a V-type internal combustion engine by increasing exhaust temperature through fuel injection timing retard or post-injection in the cylinders of the bank when the amount of the soot accumulation in the exhaust particulate filter of the bank exceeds a threshold value.

However, in V-type internal combustion engines with left and right banks, the increase in soot accumulation amount in the exhaust particulate filters of both the banks generally does not exhibit completely identical characteristics. When the soot accumulation amounts in the exhaust particulate filters of the respective banks differ significantly, the pressure loss of each of them become imbalanced. Consequently, the combustion characteristics of the two banks become imbalanced, which is undesirable. In the patent document 1, such imbalance is rather exacerbated by the regeneration of one of the exhaust particulate filters.

### SUMMARY

The present invention is a method for regenerating exhaust particulate filters in a V-type internal combustion engine having a pair of banks and the exhaust particulate filters provided in respective exhaust passages of the pair of banks, the method comprising: estimating a soot accumulation amount of each of the exhaust particulate filters of a corresponding one of the banks; and simultaneously starting regeneration process for the exhaust particulate filters of both the respective banks based on the soot accumulation amount of at least one of the exhaust particulate filters of the banks, wherein the regeneration process is terminated when the soot accumulation amount of one of the two exhaust particulate filters, which has a higher soot accumulation amount, decreases to a predetermined lower limit soot amount set to ensure collection efficiency by the regeneration process.

That is, the regeneration process is always performed for the two exhaust particulate filters provided to the respective banks, simultaneously. Then, the regeneration process is terminated when the soot accumulation amount of one of the exhaust particulate filters, which has a higher soot accumulation amount, decreases to a predetermined lower limit soot amount set to ensure collection efficiency. At the time when the regeneration process is terminated, the soot accumulation amount of the other exhaust particulate filter does not fall below zero. Consequently, the difference in soot accumulation amounts between the two exhaust particulate filters decreases with each regeneration process. In addition, the soot accumulation in one of the exhaust particulate filters does not fall below the lower limit soot accumulation amount, thereby ensuring collection efficiency.

According to the present invention, it is possible to suppress the imbalance in soot accumulation amounts between the two exhaust particulate filters while ensuring collection efficiency, thereby suppressing the imbalance in combustion characteristics between banks caused by pressure loss differences.

### BRIEF DESCRIPTION OF THE DRAWINGS

FIG. 1 is a schematic diagram of a V-type internal combustion engine in one embodiment.

FIG. 2 is a flowchart showing the basic processing flow of a regeneration process in one embodiment.

FIG. 3 is a time chart showing the operation of a first embodiment.

FIG. 4 is a time chart showing the operation of a second embodiment.

FIG. 5 is a time chart showing the operation of a third embodiment.

FIG. 6 is a characteristic diagram showing a relationship between soot accumulation amount and collection efficiency in an exhaust particulate filter.

### DETAILED DESCRIPTION

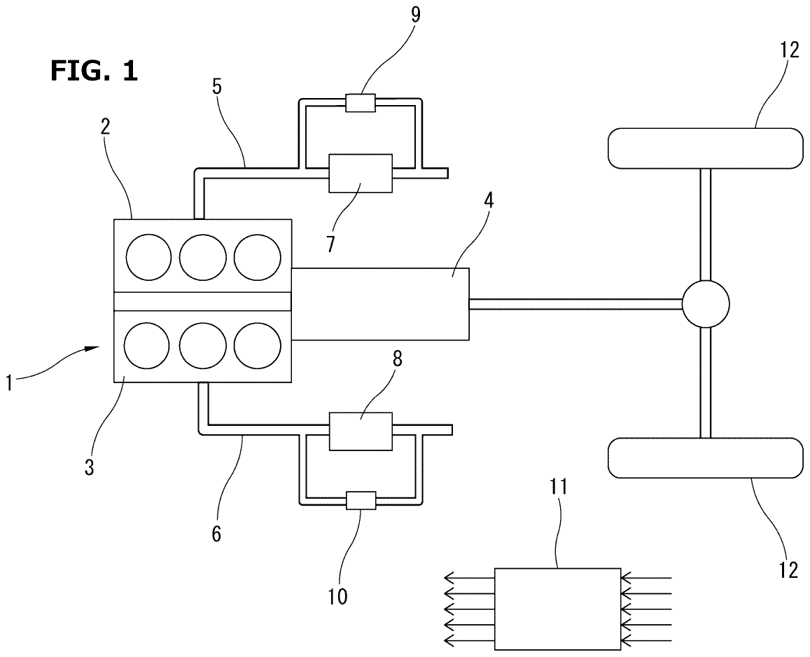

In the following, one embodiment of the present invention will be explained with reference to the drawings. FIG. 1 shows a V-type internal combustion engine 1 in an embodiment that is mounted on a vehicle. The internal combustion engine 1 is a spark-ignition internal combustion engine, commonly known as a gasoline engine, and in one embodiment, it is configured as a V-type 6-cylinder engine having a first bank 2 and a second bank 3. Furthermore, this V-type internal combustion engine 1 is mounted in the vehicle in a so-called longitudinal layout and drives rear wheels 12 via an automatic transmission 4 connected to its rear end.

The automatic transmission 4 is a stepped automatic transmission combining, for example, a torque converter and a stepped automatic transmission mechanism. In the stepped automatic transmission mechanism, as is well known, shifting is basically performed along a shift line using vehicle speed and accelerator pedal opening degree as parameters. In addition, the automatic transmission 4 may also be a continuously variable transmission (CVT) using, for example, a belt-type CVT mechanism.

The first bank 2 and the second bank 3 have exhaust passages 5 and 6, respectively, and exhaust particulate filters 7 and 8 (so-called GPF) for removing soot from the exhaust are provided in the exhaust passage 5 and 6, respectively. The exhaust particulate filters 7 and 8 consist of wall-flow type filters using, for example, a sealed-type monolithic ceramic body made of a material such as cordierite. The configuration of each of the exhaust particulate filters 7 and 8 in which coating is performed to the inner wall surfaces of fine passages (cells) with a catalyst metal to function as a three-way catalyst may be used. The exhaust particulate filters 7 and 8 may be of any type, such as metal filters.

The exhaust passages 5 and 6 respectively include differential pressure sensors 9 and 10 that detect the pressure difference across the exhaust particulate filters 7 and 8 to detect pressure loss correlated with the soot accumulation amount in the exhaust particulate filters 7 and 8. Alternatively, pressure sensors may be provided on the respective inlet and outlet sides of each of the exhaust particulate filters 7 and 8 instead of the differential pressure sensors 9 and 10.

The detection signals from the above differential pressure sensors 9 and 10 are input to an engine controller 11 that performs various controls of the internal combustion engine 1. Although not shown, the engine controller 11 receives detection signals from various sensors directly or via another controller, such as a crank angle sensor for detecting engine rotation speed, an air flow meter for detecting intake air amount corresponding to load, a water temperature sensor for detecting cooling water temperature, an accelerator pedal position sensor for detecting the opening amount (depression amount) of the accelerator pedal operated by the driver, an air-fuel ratio sensor for detecting exhaust air-fuel ratio, and a vehicle speed sensor for detecting vehicle speed. Based on these detection signals, the engine controller 11 optimally controls the fuel injection amount and injection timing by fuel injection valves, the ignition timing by spark plugs, the throttle valve opening amount, and the like. Furthermore, the engine controller 11 can provide shift instructions related to the regeneration process described later to the automatic transmission 4 via an AT controller (not shown).

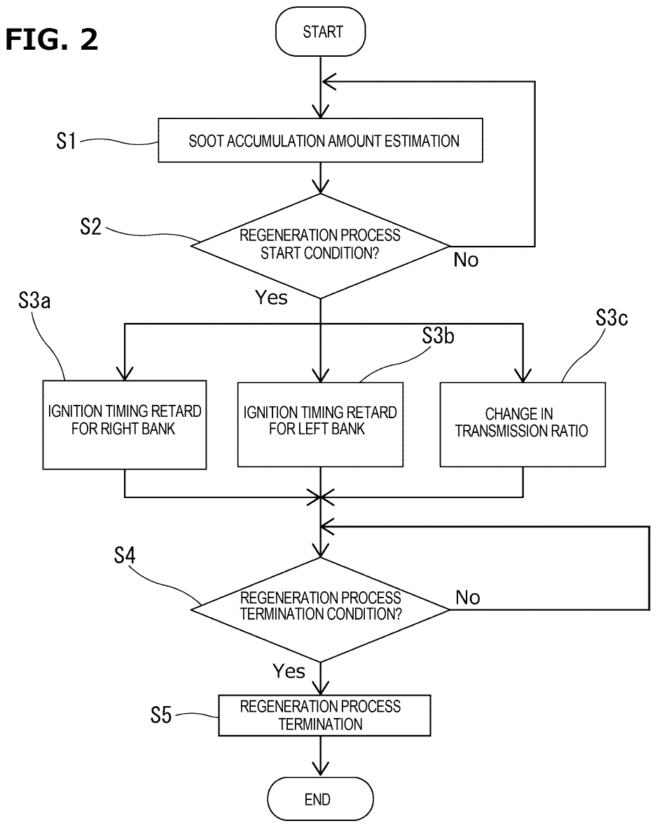

Next, FIG. 2 is a flowchart showing the basic processing flow of the regeneration process in one embodiment. First, in a step 1, the soot accumulation amount in each of the exhaust particulate filters 7 and 8 is estimated. The soot accumulation amount is estimated based on, for example, the pressure difference across the exhaust particulate filters 7 and 8 detected by the differential pressure sensors 9 and 10 described above, and the flow rate of gas passing through the exhaust particulate filters 7 and 8. The gas flow rate is a known value for each operating point (combination of rotation speed and torque) of the internal combustion engine 1 at that time. In addition, in the present invention, the estimation of the soot accumulation amount may be performed by any other known method.

Next, in a step 2, based on the soot accumulation amount in each of the exhaust particulate filters 7 and 8, it is determined whether the start condition for the regeneration process is satisfied. When it is determined that the start condition is not satisfied, the process is returned to the step 1, and the estimation of the soot accumulation amount is repeated.

When it is determined in the step 2 that the start condition for the regeneration process is satisfied, as the regeneration process, the processes of steps 3a, 3b, and 3c are performed in parallel. In the step 3a, ignition timing retard of the first bank 2 is performed in which the ignition timing of the first bank 2 is shifted from the base ignition timing toward a retarded angle. Similarly, in the step 3b, ignition timing retard of the second bank 3 is performed in which the ignition timing of the second bank 3 is shifted from the base ignition timing toward a retarded angle. The retard amount for the ignition timing of each of the two banks 2 and 3 can basically be the same. In the step 3c, the automatic transmission 4 is downshifted to a lower stage. In addition, in case of a continuously variable transmission, an appropriate change in transmission ratio is performed.

By the ignition timing retard, the exhaust temperature of each of the banks 2 and 3 increases. Furthermore, by the change in transmission ratio accompanying the downshift, the rotation speed of the internal combustion engine 1 increases, resulting in a larger amount of exhaust energy being supplied to the exhaust particulate filters 7 and 8 of the corresponding banks 2 and 3. With this, the soot in the exhaust particulate filters 7 and 8 is oxidized or burnt, thereby being removed. In other words, regeneration of the exhaust particulate filters 7 and 8 is performed.

In a step 4, based on the soot accumulation amount in the exhaust particulate filters 7 and 8, which decreases during the regeneration process, it is determined whether the regeneration process termination condition is satisfied. When it is determined that the regeneration process termination condition is not satisfied, the regeneration process continues. When the termination condition for the regeneration process is determined to be satisfied in the step 4, the process proceeds to a step 5 and the regeneration process is terminated. Specifically, the forced ignition timing retard is ended, and the transmission is returned to a stage with normal characteristics.

In this way, in the above embodiment, the regeneration process for the exhaust particulate filters 7 and 8 of both the banks 2 and 3 is always performed simultaneously. Furthermore, since, in addition to the exhaust temperature increase by the ignition timing retard in each of the banks 2 and 3, an increase in exhaust energy is performed by changing the transmission ratio, required retard amount for the ignition timing retard is relatively small, and combustion instability caused by the ignition timing retard is suppressed. Moreover, since the ignition timing retard is performed in both the banks 2 and 3, no output imbalance occurs between the left and right banks 2 and 3.

Furthermore, since the exhaust temperature increase by the change in the transmission ratio inevitably occurs in both the banks 2 and 3, fuel economy deterioration is less compared to when the exhaust particulate filters 7 and 8 for the left and right banks 2 and 3 are regenerated alternately. That is, when performing the regeneration process by combining a change in transmission ratio affecting both the banks 2 and 3 with the ignition timing retard, the fuel economy deterioration caused by the increase in rotation speed during the regeneration of only one of the exhaust particulate filters 7 and 8 is equivalent to that during simultaneous regeneration of both the banks 2 and 3. Therefore, simultaneously regenerating both the banks 2 and 3 to reduce the total number of regeneration cycles is advantageous for fuel economy.

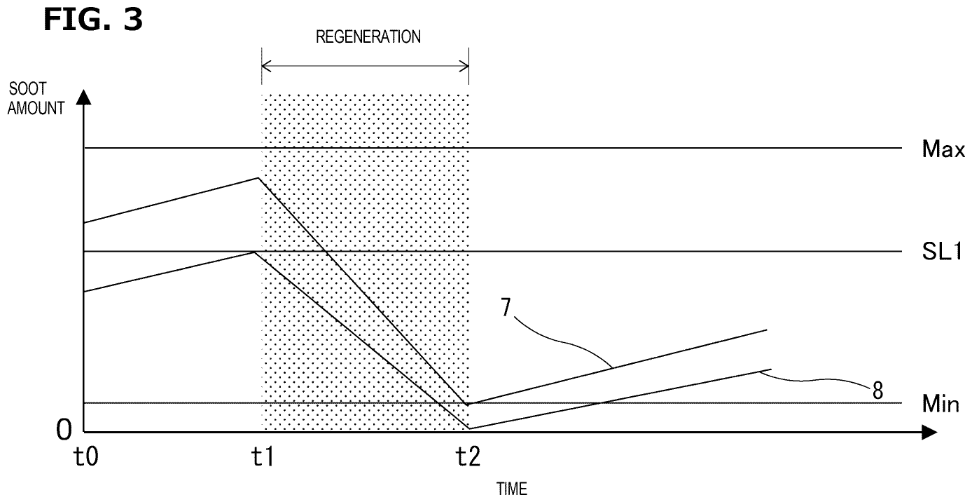

Next, FIG. 3 is a time chart showing a more specific operation of the first embodiment. In this first embodiment, as a start condition for the regeneration process, when the soot accumulation amounts of the two exhaust particulate filters 7 and 8 are compared with each other, and the soot accumulation amount of the exhaust particulate filter, which has a lower soot accumulation amount, exceeds a predetermined first threshold value SL1, the start condition for the regeneration process is satisfied. Furthermore, as the termination condition for the regeneration process after the starting of the regeneration process, when the soot accumulation amounts of the two exhaust particulate filters 7 and 8 are compared with each other, and the soot accumulation amount of the exhaust particulate filter, which has a higher soot accumulation amount, decreases to a predetermined lower limit soot amount Min, the termination condition is satisfied.

In the example of FIG. 3, the soot accumulation amount in each of the exhaust particulate filters 7 and 8 increases from time t0. For example, the soot accumulation amount in the exhaust particulate filter 8 is lower than that in the exhaust particulate filter 7, and at time t1, the soot accumulation amount in the exhaust particulate filter 8 with a lower soot accumulation amount exceeds the first threshold value SL1. Consequently, at time t1, the regeneration process starts. That is, ignition timing retard is executed for both the banks 2 and 3, and the automatic transmission 4 is downshifted to a lower stage, and then rotation speed increases. By this regeneration process, the soot accumulation amount in each of the exhaust particulate filters 7 and 8 is gradually reduced. In addition, the first threshold value SL1 is set at a level that provides a certain margin relative to the clogging level Max, which represents the soot accumulation amount that can be considered clogging of the exhaust particulate filters 7 and 8.

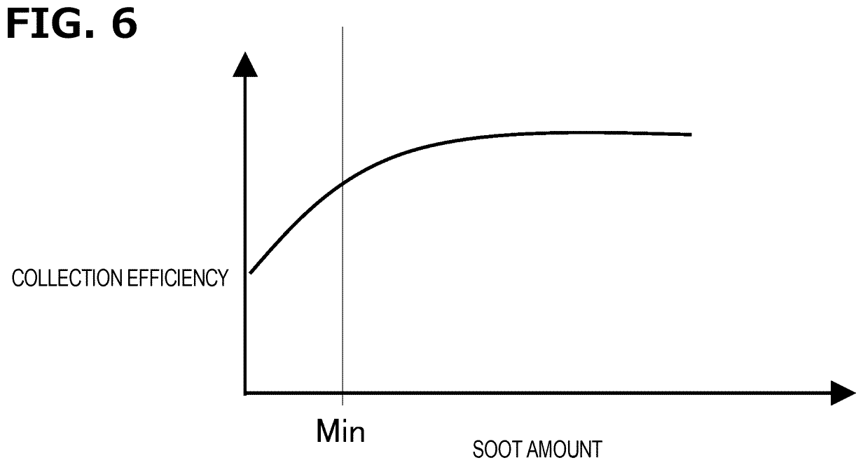

At time t2, the soot accumulation amount in the exhaust particulate filter 7, which has a higher soot accumulation amount, decreases to the lower limit soot amount Min, and the regeneration process is terminated. Here, the lower limit soot amount Min is the soot accumulation level set to ensure the collection efficiency of an exhaust particulate filter. As shown in FIG. 6, which illustrates the relationship between soot accumulation amount and collection efficiency in an exhaust particulate filter, collection efficiency decreases when the soot accumulated amount in an exhaust particulate filter is extremely low. That is, although a high soot accumulation causes greater pressure loss, from the perspective of collection efficiency that suppresses soot discharge, a certain amount of soot accumulation is desirable. Therefore, the lower limit soot amount Min is set at a level where the collection efficiency does not become excessively low, as shown in FIG. 6.

In the example of FIG. 3, when the soot accumulation in the exhaust particulate filter 7, which has a higher soot accumulation amount, decreases to the lower limit soot amount Min, the soot accumulation in the exhaust particulate filter 8, which has a lower soot accumulation amount, reaches zero.

According to the first embodiment, when the regeneration process is terminated at time t2, the soot accumulation amount in one exhaust particulate filter 7 is the lower limit soot amount Min, and the soot accumulation amount in the other exhaust particulate filter 8 does not fall below zero. Therefore, the difference therebetween becomes smaller than the range from zero to the lower limit soot amount Min. Thus, the imbalance in soot accumulation amounts between the two exhaust particulate filters 7 and 8 is eliminated with each regeneration process. In other words, even when using a regeneration method in which the regeneration process is simultaneously performed for both the banks 2 and 3, for example, by increasing the rotational speed due to a change in transmission ratio, no imbalance in soot accumulation amount occurs.

Furthermore, since the soot accumulation amount in one exhaust particulate filter 7 is limited to the lower limit soot amount Min at the termination of the regeneration process, excessive deterioration in collection efficiency can be suppressed. Therefore, as compared to continuing the regeneration process until the soot accumulation amount in both the exhaust particulate filters 7 and 8 reaches zero, the amount of the soot emission from the internal combustion engine 1 is reduced.

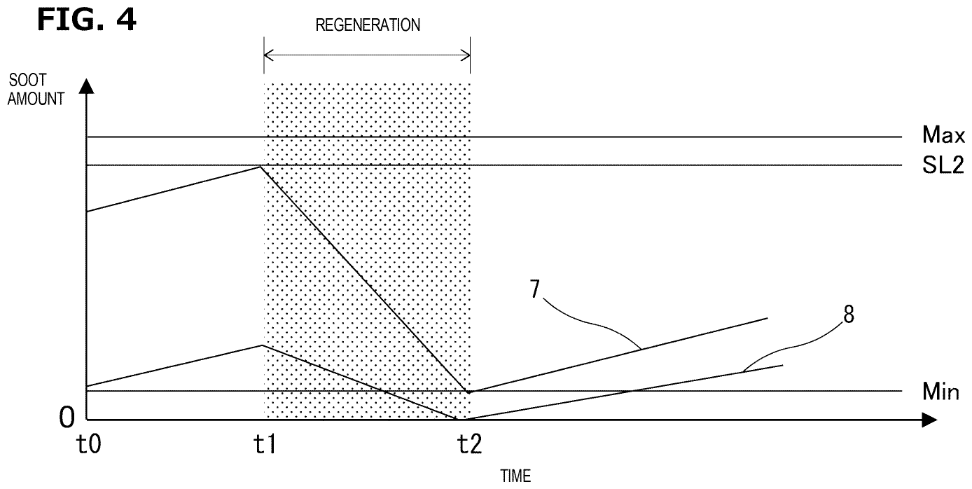

FIG. 4 is a time chart showing the operation of a second embodiment. In the second embodiment, as a start condition for the regeneration process, when the soot accumulation amounts of the two exhaust particulate filters 7 and 8 are compared with each other, and the soot accumulation amount of the exhaust particulate filter, which has a higher soot accumulation amount, exceeds a predetermined second threshold value SL2, the start condition is satisfied. Furthermore, as a termination condition for the regeneration process after starting the regeneration process, similar to the first embodiment, when the soot accumulation amounts of the two exhaust particulate filters 7 and 8 are compared with each other, and the soot accumulation amount of the exhaust particulate filter, which has a higher soot accumulation amount, reaches the predetermined lower limit soot amount Min, the termination condition is satisfied.

In the example of FIG. 4, the soot accumulation amount in each of the exhaust particulate filters 7 and 8 increases from time t0. For example, the soot accumulation amount in the exhaust particulate filter 7 is higher than that in the exhaust particulate filter 8, and at time t1, the soot accumulation amount in the exhaust particulate filter 7 with higher soot accumulation amount exceeds the second threshold value SL2. Consequently, at time t1, the regeneration process starts. Through this regeneration process, the soot accumulation amount in the two exhaust particulate filters 7 and 8 gradually decreases. Here, the second threshold value SL2 is set higher than the first threshold SL1 of the first embodiment and at a level relatively close to the clogging level Max of soot accumulation amount that can be considered clogging of the exhaust particulate filters 7 and 8.

At time t2, the soot accumulation amount in the exhaust particulate filter 7, which has a higher soot accumulation amount, decreases to the lower limit soot amount Min, thereby terminating the regeneration process. This is the same as in the first embodiment.

According to this second embodiment, it is reliably avoided that the soot accumulation amount in the exhaust particulate filter 7 with a higher soot accumulation amount reaches the clogging level Max. Furthermore, the same as in the first embodiment, the imbalance in soot accumulation amounts between the two exhaust particulate filters 7 and 8 can be suppressed during each regeneration process.

The regeneration process start conditions of the above first embodiment and second embodiment can also be applied in combination. Specifically, the first threshold value SL1 used for comparison with the soot accumulation amount of one of the two exhaust particulate filters 7 and 8, which has a lower soot accumulation amount, is set, and the second threshold value SL2 used for comparison with the soot accumulation amount of the exhaust particulate filter with higher soot accumulation amount is set, and when the soot accumulation amount of the exhaust particulate filter, which has a lower soot accumulation amount, exceeds the first threshold value SL1, or when the soot accumulation amount of the exhaust particulate filter, which has a higher soot accumulation amount, exceeds the second threshold value SL2, the regeneration process starts.

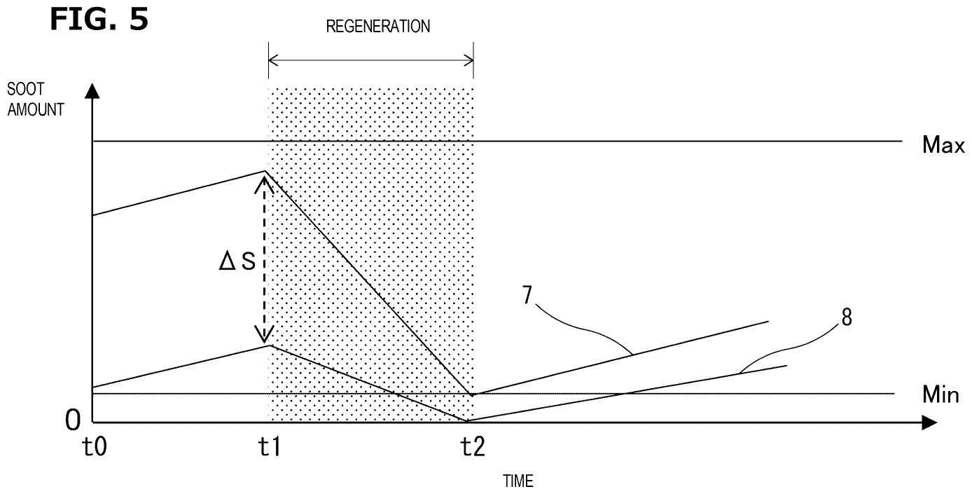

Next, FIG. 5 is a timing chart showing the operation of a third embodiment. In the third embodiment, as a start condition for the regeneration process, when the difference in soot accumulation amounts between the two exhaust particulate filters 7 and 8 exceeds a predetermined allowable soot amount difference ΔS, the start condition is satisfied. The termination condition for the regeneration process after the starting of the regeneration process is the same as in the first embodiment, and it is satisfied when the soot accumulation amount of the exhaust particulate filter, which has a higher soot accumulation amount, decreases to a predetermined lower limit soot amount Min.

In the example of FIG. 5, the soot accumulation amount of each of the exhaust particulate filters 7 and 8 increases from time t0. For example, the exhaust particulate filter 7 has a higher soot accumulation amount than the exhaust particulate filter 8, and the rate of increase in soot accumulation amount of the exhaust particulate filter 7 is higher than that of the exhaust particulate filter 8. Consequently, the difference between them gradually increases and exceeds the allowable soot amount difference ΔS at time t1. This causes the regeneration process to start at time t1. By this regeneration process, the soot accumulation amount in both the exhaust particulate filters 7 and 8 gradually decreases.

Then, at time t2, the soot accumulation amount in the exhaust particulate filter 7, which has a higher soot accumulation amount, decreases to the lower limit soot amount Min. Consequently, the regeneration process is terminated. This is the same as in the first embodiment.

Therefore, in the third embodiment, the difference in soot accumulation amounts between the two exhaust particulate filters 7 and 8 does not exceed the allowable soot difference ΔS. Furthermore, at the termination of the regeneration process, the difference in soot accumulation amounts between the two exhaust particulate filters 7 and 8 is reduced to the lower limit soot amount Min or lower. With this, it is possible to reliably suppress the occurrence of excessive imbalance in pressure loss.

The regeneration process start condition of the above third embodiment can also be applied in combination with at least one of the regeneration process start conditions of the first embodiment and the second embodiment. For example, when combining the three regeneration process start conditions, the regeneration process stars when the soot accumulation amount of the exhaust particulate filter, which has a lower soot accumulation amount, exceeds the first threshold value SL1, the soot accumulation amount of the exhaust particulate filter, which has a higher soot accumulation amount, exceeds the second threshold value SL2, or the difference in soot accumulation amounts between the exhaust particulate filters exceeds the allowable soot difference ΔS.

As the above, one embodiment of the present invention has been explained in detail. However, the present invention is not limited to the above embodiments and various changes might be made to the embodiments without departing from the scope and spirit of the present invention. The present invention includes equivalents thereof. For example, although, in the above embodiments, the regeneration process is performed by combining ignition timing retard and an increase in rotation speed via shifting, the regeneration process may be any suitable method. For example, methods such as varying the air-fuel ratio of each cylinder to rich or lean to increase exhaust temperature or increasing auxiliary load to increase the torque of the internal combustion engine 1, can be appropriately utilized. Furthermore, the present invention can also be applied to an internal combustion engine used for power generation in a series hybrid vehicle.

The entire contents of Japanese Patent Application 2024-220466 filed Dec. 17, 2024 is incorporated herein by reference.

1. A method for regenerating exhaust particulate filters in a V-type internal combustion engine having a pair of banks and the exhaust particulate filters provided in respective exhaust passages of the pair of banks, the method comprising:
estimating a soot accumulation amount of each of the exhaust particulate filters of a corresponding one of the banks; and
simultaneously starting regeneration process for the exhaust particulate filters of both the respective banks based on the soot accumulation amount of at least one of the exhaust particulate filters of the banks,
wherein the regeneration process is terminated when the soot accumulation amount of one of the two exhaust particulate filters, which has a higher soot accumulation amount, decreases to a predetermined lower limit soot amount set to ensure collection efficiency by the regeneration process.

2. The method for regenerating the exhaust particulate filters in the V-type internal combustion engine according to claim 1,
wherein the regeneration process starts when the soot accumulation amount of one of the two exhaust particulate filters, which has a lower soot accumulation amount, exceeds a predetermined first threshold value.

3. The method for regenerating the exhaust particulate filters in the V-type internal combustion engine according to claim 1,
wherein the regeneration process starts when the soot accumulation amount of one of the two exhaust particulate filters, which has a higher soot accumulation amount, exceeds a predetermined second threshold value.

4. The method for regenerating the exhaust particulate filters in the V-type internal combustion engine according to claim 1,
wherein the regeneration process starts when the soot accumulation amount of one of the two exhaust particulate filters, which has a lower soot accumulation amount, exceeds a predetermined first threshold value, or when the soot accumulation amount of one of the two exhaust particulate filters, which has a higher soot accumulation amount, exceeds a predetermined second threshold value higher than the first threshold value.

5. The method for regenerating the exhaust particulate filters in the V-type internal combustion engine according to claim 1,
wherein the regeneration process starts when a difference in the soot accumulation amount between the two exhaust particulate filters exceeds a predetermined allowable soot amount difference.

6. The method for regenerating the exhaust particulate filters in the V-type internal combustion engine according to claim 1,
wherein the regeneration process starts when the soot accumulation amount of one of the exhaust particulate filters, which has a lower soot accumulation amount, exceeds a predetermined first threshold value, the soot accumulation amount of one of the exhaust particulate filters, which has a higher soot accumulation amount, exceeds a second threshold value higher than the first threshold value, or a difference in the soot accumulation amount between the two exhaust particulate filters exceeds a predetermined allowable soot difference.

7. The method for regenerating the exhaust particulate filters in the V-type internal combustion engine according to claim 1,
wherein the V-type internal combustion engine is a spark-ignition-type engine for a vehicle which is connected with an automatic transmission, and
wherein the regeneration process is performed by retarding ignition timing of both the banks and increasing an engine rotational speed of the internal combustion engine by changing a transmission ratio of the automatic transmission.

8. A device for regenerating exhaust particulate filters in a V-type internal combustion engine, wherein the V-type internal combustion engine has a pair of banks and the exhaust particulate filters provided in respective exhaust passages of the pair of banks, the device comprising:
a controller configured to perform regeneration process for the exhaust particulate filters of the respective banks,
wherein the controller is configured to:
estimate a soot accumulation amount in each of the exhaust particulate filters of a corresponding one of the banks; and
simultaneously start the regeneration process for the exhaust particulate filters of both the banks based on the soot accumulation amount of at least one of the exhaust particulate filters of the banks, and
wherein the regeneration process is terminated when the soot accumulation amount of one of the two exhaust particulate filters, which has a higher soot accumulation amount, decreases to a predetermined lower limit soot amount set to ensure collection efficiency by the regeneration process.
